(19) United States
(12) Patent Application Publication
(10) Pub. No.: US 2010/0330922 A1
(43) Pub. Date: Dec. 30, 2010

(54) USER SELECTION METHOD AND APPARATUS FOR MULTIUSER MULTIPLE-INPUT MULTIPLE-OUTPUT

(75) Inventors: Bin LI, Shenzhen (CN); Hui SHEN, Shenzhen (CN); Yi LUO, Shenzhen (CN); Feng LIU, Shenzhen (CN); Xiadong WANG, Shenzhen (CN)

Correspondence Address: STAAS & HALSEY LLP, SUITE 700, 1201 NEW YORK AVENUE, N.W., WASHINGTON, DC, 20005, US

(73) Assignee: HUAWEI TECHNOLOGIES CO., LTD., Shenzhen (CN)

(21) Appl. No.: 12/823,828

(22) Filed: Jun. 25, 2010

(30) Foreign Application Priority Data
Jun. 26, 2009 (CN) 200910150038.6

(51) Int. Cl. H04B 17/00

(52) U.S. Cl. 455/67.11

(57) ABSTRACT

A user selection method and apparatus for multiuser multiple-input multiple-output (MIMO) are disclosed. The method includes: selecting two user-beam pairing modes, and obtaining target functions corresponding to the two user-beam pairing modes; comparing the target functions corresponding to the two user-beam pairing modes; and selecting a user-beam pairing mode with a larger target function. With the present invention, the optimal user-beam pairing mode can be quickly obtained when the channel information is inaccurate; and the calculation is simplified.

### CROSS-REFERENCE TO RELATED APPLICATION

This application claims priority to Chinese Patent Application No. 200910150038.6, filed on Jun. 26, 2009, which is hereby incorporated by reference in its entirety.

### FIELD OF THE INVENTION

The present invention relates to a communications technology, and in particular, to a user selection method and apparatus for multiuser multiple-input multiple-output (MIMO) of random beam forming.

### BACKGROUND OF THE INVENTION

Under a multiuser environment, especially when there are a large number of system users, random beam forming is a possible solution. Under the multiuser environment, random scheduling can better utilize multiuser diversity to increase the system throughput. Each user only needs to feed back a channel quality indication (CQI) to a base station. The base station selects users to use channel resources according to the collected information, and thus the amount of feedback information is greatly reduced. In a simple random beam forming scheme, a slow fading channel is manually equivalent to a fast fading channel, and a proper scheduling scheme is used to ensure the fairness between users. In another scheme, the random beam forming is extended from single-antenna user configurations to multi-antenna user configurations; the base station sends multiple data streams to a user at the same time, and may perform reasonable power distribution (water-filling) between multiple streams according to the feedback information to improve the system throughput. In fact, in a multiuser multi-antenna system, besides the multiuser diversity gain, the space division multiplexing may further improve the system throughput. The quantity of antennas (M) configured on the base station is usually larger than the quantity of user antennas (N). According to the information theory, if a timeslot of the base station sends data to one user only, the timeslot can concurrently send a maximum of min(M,N) independent data streams without mutual interference. If the base station sends data to multiple users at the same time, a timeslot can concurrently sends M independent data streams. Therefore, the base station can usually obtain more gains when serving multiple users concurrently. In another scheme, multiple pre-coding matrixes are generated at random; the base station sends data to multiple users who support the highest rate of the pre-coding matrixes; each pre-coding matrix is used as multiple beams that carry the information sent by a corresponding user. With this scheme, both the multiuser diversity gain and space division multiplexing gain may be obtained. However, because multiple pre-coding matrixes are generated at random, strong interference exists between the users, thus reducing the system performance. Some technical literature proposes that each beam should be mutually orthogonal when multiple beams carrying multiple user data are generated so as to control the interference between multiple users. However, the channel state information of the users is not used during the suppression of interference. Although the interference between multiple users may reduce the system performance to a certain degree, the interference ensures the fairness between the users. When each user generates channel responses with different statistical features due to the difference in distances between the users and the base station, the interference items at the user end may be scaled in proportion with the statistical features of the channel responses. If the impact of the interference is greater than that of noises, the CQI that each user feeds back to the base station may not vary with the channel features, and thus the scheduling fairness is affected.

When there are a lot of users, the sum capacity of the random beam forming is close to the optimal sum capacity, but the user selection (scheduling) algorithm is very complex because there are a lot of users. Therefore, a user selection algorithm with low complexity and suboptimum sum capacity has become an important research direction in the random beam forming.

The greedy selection (GS) algorithm is a usual user selection algorithm for multiuser MIMO in the random beam forming. The following describes the basic principle of the GS algorithm.

(1) The base station obtains the accurate channel information of all user downlinks.

(2) The base station calculates the SINR_{k,m} for different beams and different users, where k=1, . . . , K and M=1, . . . , Nₜ.

(3) The base station finds the largest SINR_{k,m}, and matches the beam corresponding to the largest SINR with a user.

(4) The base station repeats the preceding steps to match the remaining beams with the remaining users until all the beams are paired.

The GS algorithm is based on the assumption that the base station has obtained the accurate channel information of all the downlinks. Thus, if the channel information of the downlinks is inaccurate, the calculation accuracy of the GS algorithm is poor. In addition, because the GS algorithm uses polynomial calculations, the calculation is complex.

### SUMMARY OF THE INVENTION

Embodiments of the present invention provide a user selection method and apparatus for multiuser MIMO to simplify the calculation and improve the accuracy of the calculation result if the information is inaccurate.

A user selection method for multiuser MIMO includes: selecting two user-beam pairing modes and obtaining target functions corresponding to the two user-beam pairing modes; comparing the target functions corresponding to the two user-beam pairing modes, and selecting a user-beam pairing mode with a larger target function.

A user selection apparatus for multiuser MIMO includes: a selecting module, configured to: select two user-beam pairing modes and obtain target functions corresponding to the two user-beam pairing modes; a comparing module, configured to compare the target functions corresponding to the two user-beam pairing modes; and a controlling module, configured to select a user-beam pairing mode with a larger target function.

In embodiments of the present invention, by using a discrete, random, and optimized scheduling method, the optimal user-beam pairing mode may be quickly obtained when the channel information is inaccurate. In addition, compared with the GS algorithm, the calculation is simplified.

### BRIEF DESCRIPTION OF THE DRAWINGS

The accompanying drawings are intended for better understanding of the present invention and constitute part of this application rather than limitation of the present invention. In the accompanying drawings:

FIG. 1 is a schematic diagram illustrating orthogonal random beam forming;

FIG. 2 is a flowchart of a user selection method for multiuser MIMO according to a first embodiment of the present invention;

FIG. 3 is a flowchart of a user selection method for multiuser MIMO according to a second embodiment of the present invention;

FIG. 4 illustrates an effect of a user selection method for multiuser MIMO according to an embodiment of the present invention;

FIG. 5 illustrates an effect of a user selection method for multiuser MIMO according to an embodiment of the present invention;

FIG. 6 shows a structure of a user selection apparatus for multiuser MIMO according to a third embodiment of the present invention; and

FIG. 7 shows a structure of a user selection apparatus for multiuser MIMO according to a fourth embodiment of the present invention.

### DETAILED DESCRIPTION OF THE EMBODIMENTS

To make the objectives, technical solution and merits of the present invention clearer, a detailed description of the present invention is hereinafter given with reference to accompanying drawings and exemplary embodiments. The exemplary embodiments of the present invention and description thereof are intended for interpreting rather than limiting the present invention.

Embodiments of the present invention provide a user selection method for multiuser MIMO.

There is some description before the user selection method for multiuser MIMO is illustrated in detail. In a multiuser MIMO system, there are Nₜ transmit antennas and K users, with Nr receive antennas installed for each user. The receive signal vector of each user is yₖ(t), which is represented by the following formula:

yₖ(t)=\sqrt{γₖ}Hₖx(t)+zₖ(t),k=1, . . . , K

In the formula, zₖ indicates the white Gaussian noise of each user. If the transmitter meets the power parity constraint P, that is, E[x⁺x]≦P, γₖ is used to indicate the influence factor of these effects when different users suffer different path losses and shadow fading. In embodiments of the present invention, the block fading channel model is used. The channel block Hₖ is independent, and HₖεCN(0,1).

If the orthogonal random beam forming scheme is used, Nₜ normalized orthogonal vectors {φₘ(t)}ₘ₌₁^{N}^{ₜ} are generated according to the isotropic distribution. As shown in FIG. 1, the m^{th} information stream xₘ(t) multiplied by φₘ(t) equals a transmit signal at each time.

$$x ( t ) = {\sum }_{m = 1}^{{N}_{t}} {x}_{m} ( t ) {φ}_{m} ( t )$$

Supposing the information stream {xₘ(t)}ₘ₌₁^{N}^{ₜ} is measured independently and the average transmit power of each antenna is equal,

$$E [ {\vert {x}_{m} ( t ) \vert}^{2} ] = \frac{P}{{N}_{t}}$$

$$ρ = \frac{P}{{N}_{t}} .$$

indicates the transmit signal noise ratio of each stream.

Due to channel estimation errors, feedback delays and other reasons, only the estimated value of the sum rate can be obtained by the base station. The purpose of the scheduling algorithm is to select K users to match the Nₜ space beams optimally. If the full search method is used, there are

$$( \begin{matrix}K \\ {N}_{t}\end{matrix} ) {N}_{t} != \frac{K !}{( K - {N}_{t} ) !}$$

possibilities.

The feasible solution is defined as w₁, w₂, . . . , w_{M}, where

$$M = \frac{K !}{( K - {N}_{t} ) !}$$

and wₘ is a sequential subnet of {1,2,ᵢ −,K}, with the number equal to Nₜ. wₘ(i) is defined as the i^{th} element of wₘ.

The following formula is further defined: H[ωₘ]Δ(H_{w}_{ₘ}₍₁₎, . . . , H_{w}_{ₘ}_{(N}_{₁}₎), m=1, . . . , M indicates the channel state matrix of the feasible solution (user-beam pairing mode).

$$Φ ( H [ {ω}_{m} ] ) = {\sum }_{i = 1}^{{N}_{t}} I ( {φ}_{i} ; H ω m ( i ) )$$

indicates the sum rate corresponding to the feasible solution.

In this formula,

$$I ( {φ}_{i} ; H ω m ( i ) ) = log ( 1 + \frac{{\vert {H}_{j} {φ}_{i} \vert}^{2}}{\frac{1}{{ργ}_{j}} + {\sum }_{l \neq i} {\vert {H}_{j} {φ}_{l} \vert}^{2}} ) , \\ j = 1 , … , K , i = 1 , … , {N}_{t}$$

Obviously, the optimal beam-user pair is as follows:

$${ω}^{*} = arg {max}_{{ω}_{m} ∈ Ω} Φ ( H [ {ω}_{m} ] )$$

In an actual system, the accurate H[ωₘ] estimation cannot be obtained, and only the noise estimation Ĥ[ωₘ] can be obtained. Thus, only the noise estimation φ[ωₘ,n] of Φ(H[ωₘ]) is obtained at the n time. Supposing Φ(H[ωₘ]) is unbiased estimation, that is, Φ(H[ωₘ])=E{φ[ωₘ]}, the formula is changed to be the following:

$${ω}^{*} = arg {max}_{{ω}_{m} ∈ Ω} Φ ( H [ {ω}_{m} ] ) = arg {max}_{{ω}_{m} ∈ Ω} E ( φ [ {ω}_{m} , n ] )$$

The estimation sequences of the solutions are generated in the iteration, with each solution being closer to the optimal solution than the previous solution.

The occupation probability of ωₘ at the n^{th} iteration is π(m,n). The state probability vector is defined as π[n]=[π[1,n], . . . , π[M,n]] and eᵢ is defined as the M×1 vector, where the i^{th} element is equal to 1 and the remaining elements are equal to 0. In addition, the vector sequence {d[n]} of M×1 is defined, where d[n]=eᵢifωⁿ=ωᵢ.

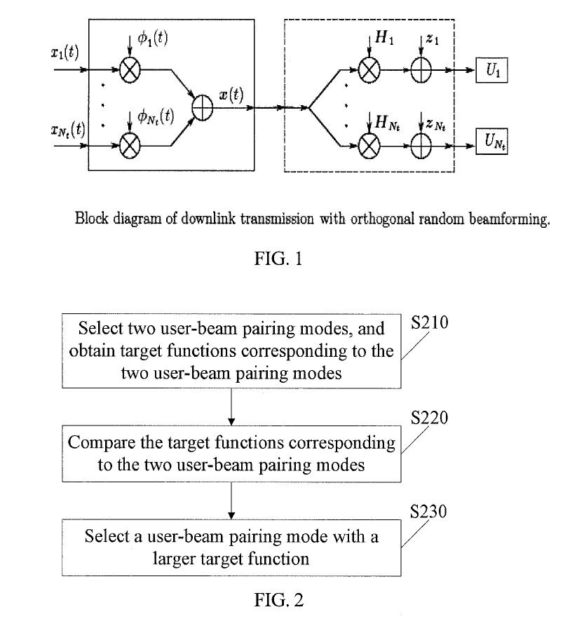

On the basis of preceding description, the following describes the user selection method for multiuser MIMO in detail with reference to FIG. 2 and embodiments of the present invention. The method includes the following steps:

Step S210: Select two user-beam pairing modes, and obtain target functions corresponding to the two user-beam pairing modes.

Step S220: Compare the target functions corresponding to the two user-beam pairing modes.

Step S230: Select a user-beam pairing mode with a larger target function.

In this embodiment, user-beam pairing modes are selected at random; and a user-beam pairing mode with a large target function is obtained through comparison. Thus, the optimal user-beam pairing mode can be obtained quickly.

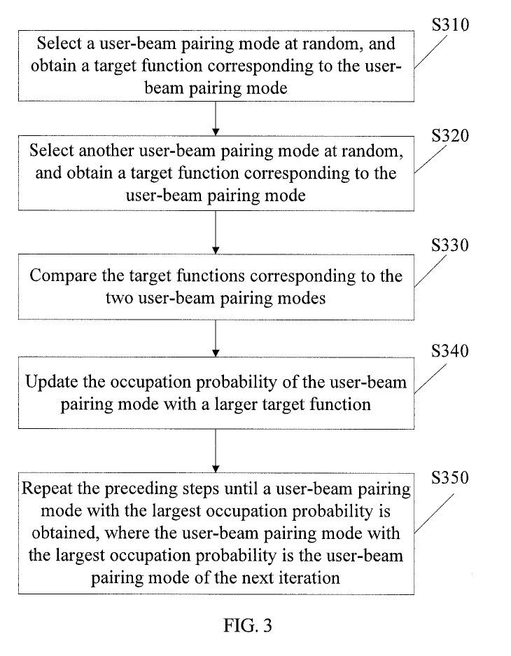

Another user selection method for multiuser MIMO is provided in an embodiment of the present invention. The following describes the user selection method for multiuser MIMO in detail with reference to FIG. 3. The method includes the following steps:

Step S310: Select a user-beam pairing mode at random, and obtain a target function corresponding to the user-beam pairing mode.

Step S310: Select another user-beam pairing mode at random, and obtain a target function corresponding to the user-beam pairing mode.

Step S320: Compare the target functions corresponding to the two user-beam pairing modes.

Step S340: Update the occupation probability of the user-beam pairing mode with a larger target function.

The occupation probability is calculated by using the following formula:

$$π [ n + 1 ] = π [ n ] + μ [ n + 1 ] ( d [ n + 1 ] - π [ n ] ) , μ [ n ] = \frac{1}{n}$$

Step S350: Repeat the preceding steps until a user-beam pairing mode with the largest occupation probability is obtained, where the user-beam pairing mode with the largest occupation probability is the user-beam pairing mode of the next iteration.

In this embodiment, a maximum iterative number may be preset to terminate the iteration process. It can also be determined to terminate the iteration process through the difference between the last target function and the current target function, that is, it can be determined to terminate the iteration process if the absolute of difference between the last target function and the current target function is smaller than the preset threshold (for example 0.01). In this way, the user-beam pairing mode which has the maximum occupation probability in the last iteration can be obtained.

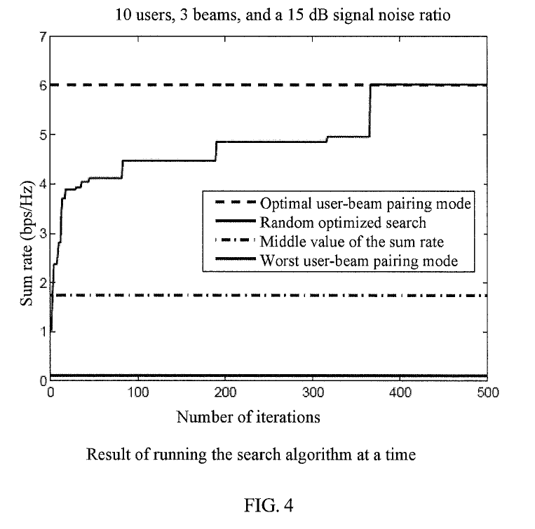

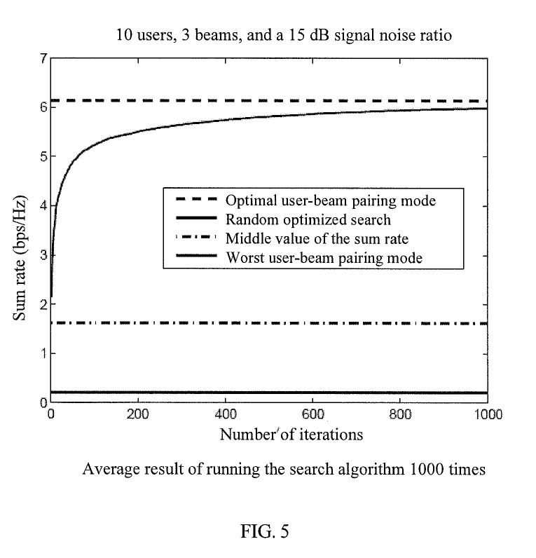

Table 1 lists the pseudo-codes of the user selection algorithm of the multiuser MIMO. The effects of this embodiment are illustrated in FIG. 4 and FIG. 5. FIG. 4 illustrates the effect of the user selection method for multiuser MIMO in an embodiment of the present invention. FIG. 5 illustrates the effect of the user selection method for multiuser MIMO in an embodiment of the present invention. As shown in FIG. 4 and FIG. 5, the optimal solution is quickly obtained under the conditions of 10 users, 3 beams and a 15 dB signal noise ratio. After more than 10 iterative searches, the obtained sum rate is far greater than the middle value of the sum rate and this algorithm is highly useful. This algorithm is especially applicable to the system with a lot of users and the user selection for multiuser MIMO with high real-time requirements.

In this embodiment, the discrete, random and optimized scheduling method is used, so that the optimal user-beam pairing mode can be obtained when the channel information is inaccurate and the calculation is simplified.

TABLE 1

| | Initialization |
|---|---|
| 1: | n [symbol] 0 |
| 2: | Select initial sets ω⁽⁰⁾, \hat{ω}⁽⁰⁾ ∈ Ω |
| 3: | Set π(0, ω⁽⁰⁾) = 1 and π(0, ω) = 0 for ω ≠ ω⁽⁰⁾ |
| 4: | for n = 0, 1, . . . do |
| | Sampling and Evaluation |
| 5: | Given ω⁽ⁿ⁾ at time n obtain φ[ω⁽ⁿ⁾, n] |
| 6: | Choose another ω̅⁽ⁿ⁾ ∈ Ω \ω⁽ⁿ⁾ uniformly |
| 7: | Given ω̅⁽ⁿ⁾ at time n obtain φ[ ω̅⁽ⁿ⁾, n] |
| | Acceptance |
| 8: | if φ[ ω̅⁽ⁿ⁾, n] > φ[ω⁽ⁿ⁾, n] then |
| 9: | Set ω⁽ⁿ⁺¹⁾ = ω̅⁽ⁿ⁾ |
| 10: | else |
| 11: | Set ω⁽ⁿ⁺¹⁾ = ω⁽ⁿ⁾ |
| 12: | end if |
| | Update Occupation Probabilities |
| 13: | $Update π [ n + 1 ] = π [ n ] + μ [ n + 1 ] ( d [ n + 1 ] - π [ n ] )$ $where μ [ n ] = \frac{1}{n}$ |
| | Compute the Maximum |
| 14: | if π[n + 1, ω⁽ⁿ⁺¹⁾] > π[n + 1, \hat{ω}⁽ⁿ⁾] then |
| 15: | \hat{ω}⁽ⁿ⁺¹⁾ = ω⁽ⁿ⁺¹⁾ |
| 16: | else |
| 17: | \hat{ω}⁽ⁿ⁺¹⁾ = \hat{ω}⁽ⁿ⁾ |
| 18: | end if |
| 19: | end for |

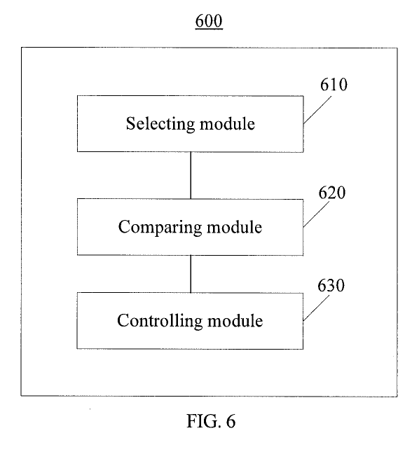

A user selection apparatus for multiuser MIMO is provided in an embodiment of the present invention. The following describes a user selection apparatus 600 for multiuser MIMO in detail with reference to FIG. 6. The user selection apparatus 600 for multiuser MIMO includes:

a selecting module 610, configured to: select two user-beam pairing modes, and obtain target functions corresponding to the two user-beam pairing modes;

a comparing module 620, configured to compare the target functions corresponding to the two user-beam pairing modes; and

a controlling module 630, configured to select a user-beam pairing mode with a larger target function.

With this apparatus, the optimal user-beam pairing mode can be quickly obtained.

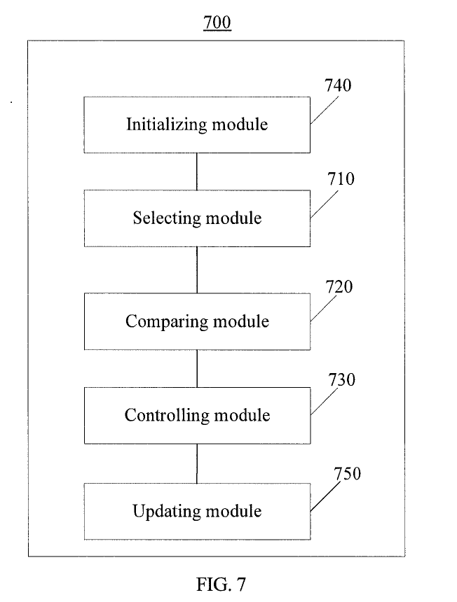

A user selection apparatus for multiuser MIMO is provided in an embodiment of the present invention, as shown in FIG. 7. Similar to the user selection apparatus 600 for multiuser MIMO shown in FIG. 6, the user selection apparatus 700 for multiuser MIMO shown in FIG. 7 includes a selecting module 710, a comparing module 720, and a controlling module 730. Different from the user selection apparatus 600 for multiuser MIMO, the user selection apparatus 700 for multiuser MIMO further includes:

an initializing module 740, configured to initialize the occupation probability of the user-beam pairing modes; and

an updating module 750, configured to update the occupation probability of a user-beam pairing mode with a larger target function.

With the user selection apparatus for multiuser MIMO in this embodiment, the optimal user-beam pairing mode can be obtained when the channel information is inaccurate; and the calculation is simplified.

The preceding embodiments describe the objective, technical solution, and benefits of the present invention in detail. It is understandable that these embodiments are merely some exemplary embodiments and are not intended to limit the scope of protection of the present invention. It is apparent that those skilled in the art can make various modifications and variations to the invention without departing from the spirit and scope of the invention. The invention shall cover the modifications and variations provided that they fall within the scope of protection defined by the following claims or their equivalents.

What is claimed is:

1. A user selection method for multiuser multiple-input multiple-output (MIMO), comprising:
selecting two user-beam pairing modes, and obtaining target functions corresponding to the two user-beam pairing modes;
comparing the target functions corresponding to the two user-beam pairing modes; and
selecting a user-beam pairing mode with a larger target function.

2. The method of claim 1, wherein the target function indicates a sum rate.

3. The method of claim 1, further comprising: updating occupation probability of the user-beam pairing mode with a larger target function.

4. The method of claim 1, further comprising:
initializing occupation probability of the user-beam pairing mode.

5. A user selection apparatus for multiuser multiple-input multiple-output (MIMO), comprising:
a selecting module, configured to: select two user-beam pairing modes, and obtain target functions corresponding to the two user-beam pairing modes;
a comparing module, configured to compare the target functions corresponding to the two user-beam pairing modes; and
a controlling module, configured to select a user-beam pairing mode with a larger target function.

6. The apparatus of claim 5, wherein the target function indicates a sum rate.

7. The apparatus of claim 5, further comprising:
an initializing module, configured to initialize occupation probability of the user-beam pairing mode.

8. The apparatus of claim 5, further comprising:
an updating module, configured to update occupation probability of the user-beam pairing mode with a larger target function.
